(19) United States
(12) Patent Application Publication
(10) Pub. No.: US 2006/0204844 A1
(43) Pub. Date: Sep. 14, 2006

(54) Battery

(76) Inventor: James R. Costanzo, Danbury, CT (US)

Correspondence Address: FISH & RICHARDSON P.C., P.O. BOX 1022, MINNEAPOLIS, MN, 55440-1022, US

(21) Appl. No.: 11/374,328

(22) Filed: Mar. 13, 2006

Related U.S. Application Data
(60) Provisional application No. 60/660,981, filed on Mar. 11, 2005.

(51) Int. Cl. H01M 10/26; H01M 4/42; H01M 4/50

(52) U.S. Cl. 429/206; 29/623.1; 429/229; 429/224

(57) ABSTRACT

Batteries and methods of making the batteries are disclosed. In some embodiments, a method of making an alkaline battery includes placing a cathode into a housing, and placing an electrolyte solution into the housing, the electrolyte solution having less than about 33 percent by weight of a hydroxide, and water.

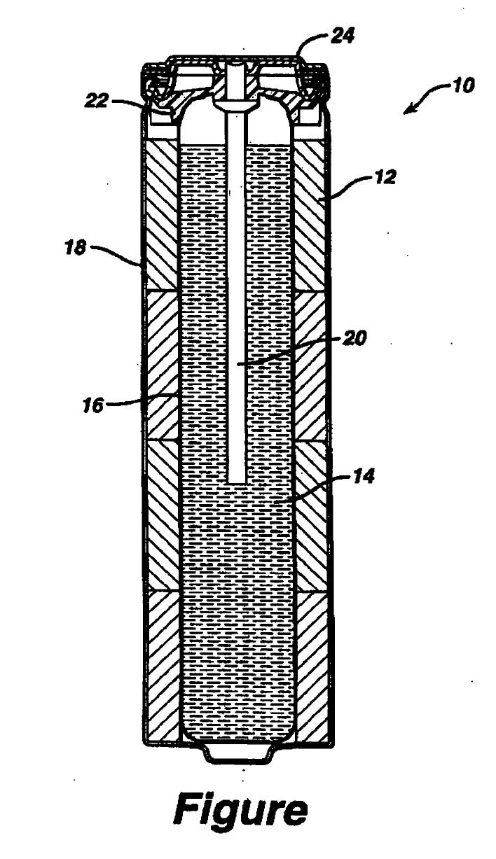

### CROSS REFERENCE TO RELATED APPLICATIONS

This application claims priority from U.S. Provisional Application Ser. No. 60/660,981, filed on Mar. 11, 2005, which is incorporated herein by reference in its entirety.

### BACKGROUND

The invention relates to batteries.

Batteries, or electrochemical cells, such as primary alkaline batteries, are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material. In order to prevent direct reaction of the anode material and the cathode material, the anode and the cathode are electrically isolated from each other by a separator.

When a battery is used as an electrical energy source in a device, such as a cellular telephone, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

### SUMMARY

In one aspect, the invention features a battery having a method of making an alkaline battery. The method includes placing a cathode into a housing, and placing an electrolyte solution into the housing, the electrolyte solution having less than about 33 percent by weight of a hydroxide, and water.

Without wishing to be bound by theory, it is believed that the electrolyte solution, which has a relatively low alkaline concentration, is capable of enhancing the performance of the battery. For example, with its relatively higher water concentration, the electrolyte solution may provide improved mass or ion transport. Good ion transport can reduce premature passivation of the anode and prolong the service life of the battery. Additionally, under some discharge conditions, the performance of the battery is enhanced. The discharge conditions may include moderate rate, intermittent discharges, such as those used by audio devices (e.g., CD players) and toys. Examples of moderate rate, intermittent discharges include a constant current discharge of 0.25A for 1 hr/day to a 0.9V cut-off, or a constant resistance discharge at 3.9 ohms to the 0.8V cut-off. High rate discharge conditions similar to those of a digital camera can also be enhanced.

Embodiments may include one or more of the following features. The anode and/or preshot used to wet the separator electrolyte solution has from about 25 percent by weight to about 33 percent by weight of the hydroxide. The electrolyte solution has from about 30 percent by weight to about 32 percent by weight of hydroxide. The electrolyte solution further includes a zinc-containing material or an indium-containing material. The electrolyte solution is contacted to a separator in the housing. The electrolyte solution is a part of an anode. The hydroxide is potassium hydroxide, the cathode includes manganese oxide, and the method further includes placing an anode comprising zinc into the housing. The battery is a primary battery.

In another aspect, the invention features an alkaline battery including a cathode, an anode having an electrolyte solution, and a separator between the cathode and the anode, wherein, prior to an initial discharge of the battery, the electrolyte solution has less than about 33 percent by weight of a hydroxide, and water.

Embodiments may include one or more of the following features. The electrolyte solution has from about 25 percent by weight to about 33 percent by weight of the hydroxide. The electrolyte solution has from about 30 percent by weight to about 32 percent by weight of hydroxide. The electrolyte solution further includes a zinc-containing material or an indium-containing material. The cathode includes manganese dioxide. The anode includes zinc. The battery is a primary battery.

Other aspects, features, and advantages will be apparent from the drawings, description, and claims.

### DESCRIPTION OF DRAWING

The Figure is a side-sectional view of a battery.

### DETAILED DESCRIPTION

Referring to the Figure, battery 10 includes a cathode 12, an anode 14, a separator 16, and a cylindrical housing 18. Battery 10 also includes a current collector 20, a seal 22, and a negative metal top cap 24, which serves as the negative terminal for the battery. Cathode 12 is in contact with housing 18, and the positive terminal of battery 10 is at the opposite end of battery 10 from the negative terminal. An electrolyte solution is dispersed throughout battery 10. As shown, battery 10 is a cylindrical battery (e.g., AA, AAA, AAAA, C, or D battery), but in other embodiments, the battery can be formed in other configurations, such as a prismatic battery or a button cell.

Cathode 12 includes a manganese oxide (such as manganese dioxide), a conductive aid to enhance the electrical conductivity of the cathode, an electrolyte solution, and optionally, a binder.

The manganese dioxide can be electrolytically-synthesized MnO₂ (EMD), or chemically-synthesized MnO₂ (CMD), or a blend of EMD and CMD. Distributors of manganese dioxides include Kerr McGee, Co. (Trona D), Erachem, Co., Tosoh, Delta Manganese, Mitsui Chemicals and JMC. In some embodiments, the manganese dioxide is EMD having a high power coefficient, as described in U.S. Pat. No. 6,509,117, filed May 1, 2000, hereby incorporated by reference in its entirety. Cathode 12 may include from about 80% to about 90%, for example, from about 84% to about 90%, from about 86% to about 90%, or about 88.3%, of manganese dioxide by weight. For example, cathode 12 can include greater than or equal to about 80, about 82, about 84, about 86, or about 88 percent by weight of manganese dioxide; and/or less than or equal to about 90, about 89, about 87, about 85, about 83, or about 81 percent by weight of manganese dioxide.

In addition, as indicated above, cathode 12 includes one or more electrically conductive additives capable of enhancing the bulk electrical conductivity of the cathode. Examples of conductive additives include natural or non-synthetic graphite, oxidation-resistant natural or non-synthetic graphite, synthetic graphite, oxidation-resistant synthetic graphite, highly graphitized carbon blacks, gold powder, cobalt oxides, e.g., cobalt oxyhydroxide, and/or carbon nanofibers. In certain embodiments, the graphite particles are nonsynthetic, nonexpanded graphite particles available from, for example, Brazilian Nacional de Grafite, Itapecirica, MG Brazil (e.g., Grafmax FP40). In other embodiments, the graphite particles are synthetic, non-expanded graphite particles, available from, for example, Timcal, Ltd., Bodio, Switzerland (e.g., Timrex® KS10, KS15, KS25). The graphite particles can be expanded graphite (e.g., Timcal BNB90). The graphite particles can be oxidation-resistant, synthetic or natural, non-expanded graphite particles. An oxidation-resistant graphite can be prepared by treating a high purity natural or synthetic, non-expanded graphite in an inert atmosphere at a high temperature, for example, greater than about 2500° C. or greater than about 3000° C. It is believed that by treating a high purity synthetic or natural graphite at a high graphitization temperature for an extended period of time, a graphite having a higher degree of crystallinity, a larger average crystallite size, fewer surface defects, a lower specific surface area, and a higher chemical purity (e.g., lower ash content) than the starting graphite can be produced. In some embodiments, the maximum ash content is less than about 0.1% by weight, for example, less than about 0.05% by weight. Oxidation-resistant synthetic or natural graphites are available from, for example, Timcal, Ltd., Bodio, Switzerland (e.g., Timrex® SFG10, SFG15, SFG44, SLP30) or Superior Graphite Co., Chicago, Ill. (e.g., 2939 APH-M).

Mixtures of conductive additives can be used. For example, a mixture of graphite particles (e.g., including from about 10 to about 100 weight percent of oxidation-resistant graphite) and carbon nanofibers can be used. Carbon nanofibers are described, for example, in commonly-assigned U.S. Ser. No. 09/658,042, filed Sep. 7, 2000, and U.S. Ser. No. 09/829,709, filed Apr. 10, 2001. As another example, mixture of 40% by weight of non-expanded graphite (Brazilian Nacional de Grafite, Grafmax FP40) and 60% by weight of expanded graphite (Timcal BNB90) can be used. Cathode 12 can include from about 3 to about 8 percent by weight, for example, about 4.8 percent by weight, of one or more conductive additives. For example, cathode 12 can include greater than or equal to about 3, about 4, about 5, about 6, or about 7 percent by weight of the conductive additive; and/or less than or equal to about 8, about 7, about 6, about 5, or about 4 percent by weight of the conductive additive.

An electrolyte solution is dispersed throughout cathode 12, such as at about 5-7 (e.g., 6.9) percent by weight. Weight percentages provided herein are determined after the electrolyte solution is dispersed in cathode 12. The electrolyte solution can be any of the electrolyte solutions commonly used in alkaline batteries. The electrolyte solution can be an alkaline solution, such as an aqueous (deionized water) alkali metal hydroxide solution, e.g., LiOH, NaOH, KOH, or mixtures of alkali metal hydroxide solutions (e.g., KOH and NaOH, KOH and LiOH). The aqueous alkali metal hydroxide solution can include between about 31 and about 40 percent by weight of the alkali metal hydroxide. The aqueous alkali metal hydroxide solution in cathode 12 can be greater than or equal to about 31, about 32, about 33, about 34, about 35, about 36, about 37, about 38, or about 39 percent by weight; and/or less than or equal to about 40, about 39, about 38, about 37, about 36, about 35, about 34, about 33, or about 32 percent by weight of the alkali metal hydroxide.

An optional binder can be added to enhance the structural integrity of cathode 12, with a commensurate reduction of the amount of manganese dioxide. Examples of binders include polyethylene powders, polyacrylamides, Portland cement, and various fluorocarbon resins, such as polyvinylidenefluoride (PVDF) and polytetrafluoroethylene (PTFE). An example of a polyethylene binder is sold under the tradename Coathylene HA-1681 (available from Hoescht). Cathode 12 can include, for example, from about 0.1 percent to about 2 percent by weight of binder. Cathode 12 also can include other optional additives. Examples of these additives are disclosed, for example, in U.S. Pat. No. 5,342,712, which is hereby incorporated by reference. Cathode 12 may include, for example, from about 0.2 weight percent to about 2 percent TiO₂ weight.

Anode 14 includes an anode active material (such as zinc), an electrolyte gel, and optionally, one or more additives.

Anode 14 can include any of the zinc materials used in alkaline battery anodes. For example, anode 14 can be a gel that includes zinc metal particles and/or zinc alloy particles, a gelling agent, and minor amounts of additives, such as a gassing inhibitor. In addition, a portion of the electrolyte solution is dispersed throughout the anode.

The zinc particles can be any of the zinc particles used in gelled zinc anodes. Examples of zinc particles include those described in U.S. Pat. Nos. 6,284,410; 6,472,103; 6,521,378; and commonly-assigned U.S. Ser. No. 10/29,575 and U.S. Ser. No. 10/113,075, all hereby incorporated by reference. The zinc-based particles can further include zinc fines, e.g., mixed with zinc particles having a larger mean average particle size. The zinc fines may include zinc-based particles small enough to pass through a 200 mesh size sieve (or a sieve having square openings of 0.075 mm). The zinc fines can further include zinc-based particles small enough to pass through a 325 mesh size sieve (or a sieve having square openings of 0.045 mm). The anode can include at least 10 weight percent, at least 15 weight percent, at least 30 weight percent, or at least 80 weight percent, of the total zinc-based particles in the form of zinc fines. Even very small amounts of zinc fines, for example, at least about 5 weight percent, or at least about 1 weight percent of the total zinc-based particles can have a beneficial effect on anode performance. The total zinc-based particles in the anode can consist of only zinc fines, of no zinc fines, or a mixture of zinc fines (e.g., between about 35 to about 75 weight percent) and larger size zinc particles. A mixture of zinc-based particles can provide good overall performance with respect to rate capability of the anode for a broad spectrum of drain rate requirements as well as provide good storage characteristics. Anode 14 may include by weight between about 50% and about 80% of zinc particles. For example, anode 14 can include greater than or equal to about 50, about 52, about 54, about 56, about 58, about 60, about 62, about 64, about 66, about 68, about 70, about 72, about 74, about 76, or about 78 percent by weight of the zinc particles; and/or less than or equal to about 80, about 78, about 76, about 74, about 72, about 70, about 68, about 66, about 64, about 62, about 60, about 58, about 56, about 54, or about 52 percent by weight of the zinc particles.

The electrolyte solution in anode 14 is in the form of a gel. The electrolyte solution in anode 14 can be any of the electrolyte solutions commonly used in alkaline batteries. The electrolyte solution can be an alkaline solution, such as an aqueous (deionized water) alkali metal hydroxide solution, e.g., LiOH, NaOH, KOH, or mixtures of alkali metal hydroxide solutions (e.g., KOH and NaOH, KOH and LiOH). The aqueous alkali metal hydroxide solution can include from about 25 to about 33 percent by weight of the alkali metal hydroxide, such as about 31.15 percent by weight. The aqueous alkali metal hydroxide solution can include greater than or equal to about 25, about 25.5, about 26, about 26.5, about 27, about 27.5, about 28, about 28.5, about 29, about 29.5, about 30, about 30.5, about 31, about 31.5, about 32, or about 32.5 percent by weight of the alkali metal hydroxide; and/or less than or equal to about 33, about 32.5, about 32, about 31.5, about 31, about 30.5, about 30, about 29.5, about 29, about 28.5, about 28, about 27.5, about 27, about 26.5, about 26, or about 25.5 percent by weight of the alkali metal hydroxide.

Examples of gelling agents include polyacrylic acids, grafted starch materials, salts of polyacrylic acids, polyacrylates, carboxymethylcellulose or combinations thereof. Examples of polyacrylic acids are Carbopol 940 and 934 (available from Noveon) and Polygel 4P (available from 3V), and an example of a grafted starch material is Waterlock A221 (available from Grain Processing Corporation, Muscatine, Iowa). An example of a salt of a polyacrylic acid is Alcosorb G1 (available from Ciba Specialties). The anode may include, for example, from 0.1 percent to about 2 percent gelling agent by weight.

Gassing inhibitors can be inorganic materials, such as bismuth, tin, lead and indium included in alloys with zinc or soluble compounds, such as indium acetate, indium hydroxide, indium chloride, indium sulfate, bismuth oxide, and barium hydroxide, included in the anode. In some embodiments, the electrolyte solution also can include up to about 6 percent by weight zinc oxide, e.g., about 2 percent by weight zinc oxide. Gassing inhibitors can be organic compounds, such as phosphate esters, ionic surfactants or nonionic surfactants. Examples of ionic surfactants are disclosed in, for example, U.S. Pat. No. 4,777,100, which is hereby incorporated by reference.

An example of anode 14 can be made by forming a gelled electrolyte, and combining the gelled electrolyte with zinc particles. The gelled electrolyte can be prepared by combining, based on the gel mass, 1.6% of a polyacrylic acid gelling agent (Carbopol 940) and 0.25% of a starch grafted polyacrylonitrile gelling agent (Waterlock A221) with an electrolyte solution in a blender. The electrolyte solution can include 31.15% KOH, 2.0% ZnO, and 66.85% deionized water. The gelled electrolyte may be allowed to stand for at least 12 hours. Based on the mass of zinc in the final anode, 50 ppm of a phosphate ester surfactant (RM510 from Rhodia) and 150 ppm In as 13% InCl₃ solution can be blended into the gelled electrolyte. Vacuum can be applied to the blending container to remove trapped gas from the gelled electrolyte. Subsequently, vacuum can be stopped, and enhanced zinc powder made by centrifugal atomization can be added to the gelled electrolyte to create a slurry of 72% Zn and 28% gelled electrolyte. Vacuum can be applied, and the zinc and electrolyte gel can be blended until a uniform suspension is formed.

Separator 16 can have any of the designs for alkaline battery separators. In some embodiments, separator 16 can be formed of two layers of a non-woven, non-membrane material with one layer being disposed along a surface of the other. To minimize the volume of separator 16 while providing an efficient battery, each layer of non-woven, non-membrane material can have a basis weight of about 54 grams per square meter, a thickness of about 5.4 mils when dry and a thickness of about 10 mils when wet. In these embodiments, the separator may not include a layer of membrane material or a layer of adhesive between the non-woven, non-membrane layers. The layers can be substantially devoid of fillers, such as inorganic particles. In some embodiments, the separator can include inorganic particles.

In other embodiments, separator 16 can include an outer layer of cellophane and a layer of non-woven material. The separator also can include an additional layer of non-woven material. The cellophane layer can be adjacent to cathode 12. The non-woven material can contain from about 78 weight percent to about 82 weight percent polyvinylalcohol (PVA) and from about 18 weight percent to about 22 weight percent rayon and a trace amount of surfactant. Non-woven materials are available from PDM under the tradename PA25A and PA25AC. An example of a separator including a layer of cellophane and a non-woven material is Duralam DT225 (Duracell Inc., Aarschot, Belgium). Another example of a separator includes an inner layer of PA25A, and an outer layer of DT225AC.

Housing 18 can be any conventional housing commonly used in alkaline batteries. The housing typically includes an inner metal wall and an outer electrically non-conductive material such as heat shrinkable plastic. Optionally, a layer of conductive material can be disposed between the inner wall and the cathode 12. This layer may be disposed along the inner surface of wall, along the circumference of cathode 12 or both. This conductive layer can be formed, for example, of a carbonaceous material. Such materials include LB1000 (Timcal), Eccocoat 257 (W.R. Grace & Co.), Electrodag 109 (Acheson Colloids Co.), Electrodag 112 (Acheson) and EB0005 (Acheson). Methods of applying the conductive layer are disclosed in, for example, Canadian Patent No. 1,263,697, which is hereby incorporated by reference.

Current collector 20 is made from a suitable metal, such as brass. Seal 22 can be made, for example, of nylon.

Battery 10 can be assembled using standard techniques. In some embodiments, one or more annular pellets of the cathode are made (e.g., by compaction) and placed in the housing. The pellets can be re-compacted in the housing to provide good electrical contact with the housing. A separator is then placed in the housing. The separator can be formed in situ in the housing or outside the housing. An amount of the electrolyte solution used to make the anode, sometimes called a “preshot”, is then added to wet the separator to provide good mass transport across the separator. The “preshot” can be from 0.755 mL to about 1.133 mL (e.g., about 0.967 ml or 1.28 g) of the electrolyte solution. The anode can then be dispensed into the separator, and the housing can be sealed, for example, by crimping the housing over the seal.

Battery 10 can be a primary cell, or a secondary or rechargeable cell. Primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995). Secondary electrochemical cells can be recharged for many times, e.g., more than fifty times, more than a hundred times, or more. In some cases, secondary cells can include relatively robust separators, such as those having many layers and/or that are relatively thick. Secondary cells can also be designed to accommodate for changes, such as swelling, that can occur in the cells. Secondary cells are described, e.g., in Falk & Salkind, “Alkaline Storage Batteries”, John Wiley & Sons, Inc. 1969; U.S. Pat. No. 345,124; and French Patent No. 164,681, all hereby incorporated by reference.

The following example is illustrative and not intended to be limiting.

### EXAMPLE

This example illustrates a method of making a battery.

The cathode, the anode, and the separator can be as follows. The cathode can include 88.3% by weight of EMD, 4.8% by weight of a 40/60 mixture of non-expanded graphite (Grafmax FP40) and expanded graphite (Timcal BNB90), and 6.9% by weight of KOH solution (36.1% by weight or 8.7N). The gelled anode can be formed as described above using an electrolyte solution containing 31.15% by weight KOH, 2% by weight ZnO, and 66.85% deionized water. The cathode:anode cell balance can be 1.022:1. The separator can be a two-layer structure with an inner layer of PA25A and an outer layer of DT225AC.

After annular pellets of the cathode are formed, it can be placed in a housing and recompacted to provide good contact with the housing. The separator can be placed in the housing. A “preshot” of 0.967 mL of the electrolyte used to make the gelled anode can then added into the housing to wet the separator. After allowing the separator to absorb the preshot of electrolyte, the anode can be dispensed into the housing. The housing can then be sealed by crimping the housing over a seal containing a current collector.

All publications, references, applications, and patents referred to herein are incorporated by reference in their entirety.

Other embodiments are in the claims.

What is claimed is:

1. A method of making an alkaline battery, the method comprising:
placing a cathode into a housing; and
placing an electrolyte solution into the housing, the electrolyte solution comprising less than 33 percent by weight of a hydroxide, and water.

2. The method of claim 1, wherein the electrolyte solution comprises from about 25 percent by weight to 33 percent by weight of the hydroxide.

3. The method of claim 1, wherein the electrolyte solution comprises from about 30 percent by weight to about 32 percent by weight of hydroxide.

4. The method of claim 1, wherein the electrolyte solution further comprises a zinc-containing material or an indium-containing material.

5. The method of claim 1, wherein the electrolyte solution is contacted to a separator in the housing.

6. The method of claim 1, wherein the electrolyte solution is a part of an anode.

7. The method of claim 1, wherein the hydroxide is potassium hydroxide, the cathode comprises manganese oxide, and the method further comprises placing an anode comprising zinc into the housing.

8. The method of claim 1, wherein the battery is a primary battery.

9. An alkaline battery, comprising:
a cathode;
an anode comprising an electrolyte solution; and
a separator between the cathode and the anode,
wherein, prior to an initial discharge of the battery, the electrolyte solution comprises less than 33 percent by weight of a hydroxide, and water.

10. The battery of claim 9, wherein the electrolyte solution comprises from about 25 percent by weight to 33 percent by weight of the hydroxide.

11. The battery of claim 9, wherein the electrolyte solution comprises from about 30 percent by weight to about 32 percent by weight of hydroxide.

12. The battery of claim 9, wherein the electrolyte solution further comprises a zinc-containing material or an indium-containing material.

13. The battery of claim 9, wherein the cathode comprises manganese dioxide.

14. The battery of claim 9, wherein the anode comprises zinc.

15. The battery of claim 9, wherein the battery is a primary battery.
